(19) United States
(12) Patent Application Publication
(10) Pub. No.: US 2019/0394186 A1
(43) Pub. Date: Dec. 26, 2019

(54) CONTENT PRESETTING METHOD AND APPARATUS

(71) Applicant: BAIDU ONLINE NETWORK TECHNOLOGY (BEIJING) CO., LTD., Beijing (CN)

(72) Inventors: Hongwei CAO, Beijing (CN); Chao YUAN, Beijing (CN); Ye WANG, Beijing (CN)

(21) Appl. No.: 16/563,142

(22) Filed: Sep. 6, 2019

(30) Foreign Application Priority Data
Nov. 30, 2018 (CN) 201811460004.2

(51) Int. Cl. H04L 29/06; G06Q 20/40; G06Q 20/42; G06Q 30/06

(52) U.S. Cl. CPC H04L 63/083; G06Q 30/0613; G06Q 20/42; G06Q 20/4014

(57) ABSTRACT

The present disclosure provides content presetting method and apparatus. The method includes: receiving, by a server, a presetting request sent by a first terminal, where the presetting request is used to instruct to preset contents of a second terminal, and the presetting request includes: contents requested for presetting; generating, by the server, a first authentication identification according to the contents requested for presetting; receiving, by the server, an authentication request sent by the second terminal, where the authentication request includes: a second authentication identification; and determining, by the server, according to both the first authentication identification and the second authentication identification, whether the second terminal is allowed to access the contents requested for presetting. Therefore, personalized requirements for product contents of a user are met, and a simple process and a high user experience are achieved.

### CROSS-REFERENCE TO RELATED APPLICATION

This application claims priority to Chinese Patent Application No. 201811460004.2, filed on Nov. 30, 2018, which is hereby incorporated by reference in its entirety.

### TECHNICAL FIELD

The present disclosure relates to the field of the Internet technology, and in particular, to content presetting method and apparatus.

### BACKGROUND

When purchasing an intelligent hardware, a user pays more attention to services and contents brought by the intelligent hardware. For example, when purchasing an intelligent speaker, the user pays attention to whether contents that can be played by the intelligent speaker meet personalized requirements of the user. Therefore, content presetting of an intelligent hardware product can improve a user experience.

In the prior art, content presetting is mainly completed as follows: after purchasing a product, the user performs an operation on the product by himself to complete content loading. However, steps and processes of the user's own operation are cumbersome, and it is difficult to achieve a good user experience.

### SUMMARY

The present disclosure provides content presetting method and apparatus for solving the problem in the prior art that the steps and processes of the user's own operation are cumbersome, and it is difficult to achieve a good user experience.

In a first aspect, the present disclosure provides a content presetting method, including:

receiving, by a server, a presetting request sent by a first terminal, where the presetting request is used to instruct to preset contents of a second terminal, and the presetting request includes: contents requested for presetting;

generating, by the server, a first authentication identification according to the contents requested for presetting;

receiving, by the server, an authentication request sent by the second terminal, where the authentication request includes: a second authentication identification; and

determining, by the server, according to both the first authentication identification and the second authentication identification, whether the second terminal is allowed to access the contents requested for presetting.

In an embodiment, the presetting request includes: the contents requesting for presetting and a first user identification;

before the receiving, by the server, an authentication request sent by the second terminal, the method further includes:

receiving, by the server, a payment successful message sent by the first terminal, where the payment successful message is used to indicate that a user identified by the first user identification completes a payment for the second terminal; and

returning, by the server, the first authentication identification to the user identified by the first user identification according to both the payment successful message and the first user identification.

In an embodiment, the authentication request includes: the second authentication identification and a second user identification;

the determining, by the server, according to both the first authentication identification and the second authentication identification, whether the second terminal is allowed to access the contents requested for presetting, includes:

determining, by the server, according to the first user identification, the second user identification, the first authentication identification, and the second authentication identification, whether the second terminal is allowed to access the contents requested for presetting.

In an embodiment, determining, by the server, according to the first user identification, the second user identification, the first authentication identification, and the second authentication identification, whether the second terminal is allowed to access the contents requesting for presetting, includes:

allowing the second terminal to access the contents requested for presetting if the first user identification matches the second user identification, and the first authentication identification matches the second authentication identification.

In an embodiment, before the generating, by the server, a first authentication identification according to the contents requested for presetting, the method further includes:

judging, by the server, whether there are contents belonging to a third-party resource in the contents requested for presetting; and

if so, authorizing the contents belonging to the third-party resource.

In an embodiment, the first authentication identification includes: a text identification, a two-dimensional code, or a voice password.

In a second aspect, the present disclosure provides a content presetting method, including:

sending, by a first terminal, a presetting request to a server, where the presetting request is used to instruct to preset contents of a second terminal, and the presetting request includes: contents requested for presetting and a first user identification, so as to enable the server to generate a first authentication identification according to the contents requested for presetting;

sending, by the first terminal, a payment successful message to the server, where the payment successful message is used to indicate that a user identified by the first user identification completes a payment for the second terminal; and

receiving, by the first terminal, a first authentication identification sent by the server.

In a third aspect, the present disclosure provides a content presetting apparatus, including:

a receiving module, configured to receive a presetting request sent by a first terminal, where the presetting request is used to instruct to preset contents of a second terminal, and the presetting request includes: contents requested for presetting;

a generating module, configured to generate a first authentication identification according to the contents requested for presetting;

the receiving module is further configured to receive an authentication request sent by the second terminal, where the authentication request includes: a second authentication identification; and

a determining module, configured to determine, according to both the first authentication identification and the second authentication identification, whether the second terminal is allowed to access the contents requested for presetting.

In an embodiment, the presetting request includes: the contents requested for presetting and a first user identification, the above apparatus further includes: a returning module;

the receiving module is further configured to receive a payment successful message sent by the first terminal, where the payment successful message is used to indicate that a user identified by the first user identification completes a payment for the second terminal; and

the returning module is configured to return the first authentication identification to the user identified by the first user identification according to both the payment successful message and the first user identification.

In an embodiment, the authentication request includes: the second authentication identification and a second user identification; and the determining module is specifically configured to determine according to the first user identification, the second user identification, the first authentication identification, and the second authentication identification, whether the second terminal is allowed to access the contents requested for presetting.

In an embodiment, the determining module is specifically configured to allow the second terminal to access the contents requested for presetting if the first user identification matches the second user identification, and the first authentication identification matches the second authentication identification.

In an embodiment, the above apparatus, further includes:

a judging module, configured to judge whether there are contents belonging to a third-party resource in the contents requested for presetting; and

if so, authorize the contents belonging to the third-party resource.

In an embodiment, the first authentication identification includes: a text identification, a two-dimensional code, or a voice password.

In a fourth aspect, the present disclosure provides a content presetting apparatus, including:

a sending module, configured to send a presetting request to a server, where the presetting request is used to instruct to preset contents of a second terminal, and the presetting request includes: contents requested for presetting and a first user identification, so as to enable the server to generate a first authentication identification according to the contents requested for presetting;

the sending module is further configured to send a payment successful message to the server, where the payment successful message is used to indicate that a user identified by the first user identification completes a payment for the second terminal; and

a receiving module, configured to receive the first authentication identification sent by the server.

In a fifth aspect, the present disclosure provides a computer readable storage medium with a computer program stored thereon, where the computer program, when executed by a processor, implements steps of the server side or of the first terminal side in the above content presetting method.

In a sixth aspect, the present disclosure provides a server, including:

a processor;

a memory, configured to store executable instructions of the processor;

where the processor is configured to implement steps of the server side in the above content presetting method by executing the executable instructions.

In a seventh aspect, the present disclosure provides a terminal, including:

a processor;

a memory, configured to store executable instructions of the processor;

where the processor is configured to implement steps of the first terminal side in the above content presetting method by executing the executable instructions.

In the content presetting method and apparatus according to the present disclosure, when purchasing an intelligent hardware product, the user may send the presetting request to the server through the first terminal, the server generates the first authentication identification according to the contents requested for presetting by the user, upon receiving the second authentication identification sent by the user through the intelligent hardware product, the server judges whether the second authentication identification matches the first authentication identification, and if so, the user is allowed to access the preset contents through the intelligent hardware product, which meets personalized requirements for product contents of the user and achieves a simple process and a high user experience.

### BRIEF DESCRIPTION OF THE DRAWINGS

In order to more clearly illustrate the technical solutions in the embodiments of the present disclosure or in the prior art, a brief introduction to the drawings used for describing the embodiments or the prior art will be made below. Obviously, the drawings in the following description show some embodiments of the present disclosure, and those skilled in the art may still derive other drawings from these drawings without any creative effort.

FIG. 1 is an application scenario diagram of a content presetting method according to the present disclosure;

FIG. 2 is another application scenario diagram of a content presetting method according to the present disclosure;

FIG. 3 is a signaling flowchart of Embodiment I of a content presetting method according to the present disclosure;

FIG. 4 is a schematic diagram of a user interface according to the present disclosure;

FIG. 5 is a signaling flowchart of Embodiment II of a content presetting method according to the present disclosure;

FIG. 6 is a schematic structural diagram of Embodiment I of a content presetting apparatus according to the present disclosure;

FIG. 7 is a schematic structural diagram of Embodiment II of a content presetting apparatus according to the present disclosure;

FIG. 8 is a schematic structural diagram of hardware of a server according to the present disclosure; and

FIG. 9 is a schematic structural diagram of hardware of a terminal according to the present disclosure.

### DESCRIPTION OF EMBODIMENTS

To make the purposes, technical solutions and advantages of the embodiments of the present disclosure clearer, the technical solutions in the embodiments of the present disclosure will be clearly and completely described below with reference to the drawings in the embodiments of the present disclosure. Apparently, the described embodiments are some but not all of the embodiments of the present disclosure. All other embodiments obtained by those skilled in the art based on the embodiments of the present disclosure without creative efforts fall within the protection scope of the present disclosure.

Terms “first”, “second”, “third” and “fourth” and the like (if any) in the specification and the claims of the present disclosure and in the drawings described above are used to distinguish similar objects rather than describe a specific order or sequence. It should be understood that data used in this way is interchangeable where appropriate so that the embodiments of the present disclosure described herein can be implemented in a sequence other than those illustrated or described herein. Terms “including”, “comprising” and any variations thereof are intended to cover a non-exclusive inclusion. For example, a process, a method, a system, a product, or a device include a series of steps or units are not necessarily limited to those steps or units clearly listed, but may include other steps or units that are not clearly listed or that are inherent to such process, method, product or device.

For an intelligent hardware product, a user pays more attention to services and contents brought by the intelligent hardware product. In the prior art, methods for presetting contents of the intelligent hardware product include:

1) the manufacturer directly presets the contents when the intelligent hardware product leaves the factory.

2) the user performs an operation on the product by himself to complete content loading after purchasing the product.

For the above method 1), contents preset by the manufacturer is not necessarily the contents that the user needs. For the above method 2), steps and processes of the user's own operation are cumbersome, and it is difficult to achieve a good user experience.

Based on the above technical problem, the present disclosure provides content presetting method and apparatus. The user, when purchasing an intelligent hardware product, may edit contents intended to be preset, the server generates a first authentication identification according to the contents edited by the user, upon receiving a second authentication identification sent by the user through the intelligent hardware product, the server judges whether the second authentication identification matches the first authentication identification, and if so, the user is allowed to access the preset contents through the intelligent hardware product, which meets personalized requirements for product contents of the user and achieves a simple process and a high user experience.

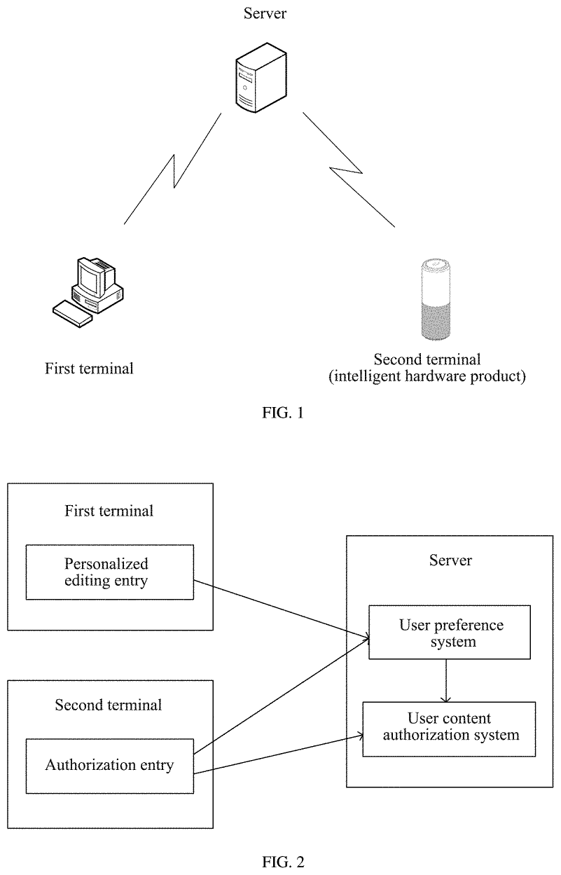

FIG. 1 is an application scenario diagram of a content presetting method according to the present disclosure. The application scenario diagram shown in FIG. 1 includes: a first terminal, a server, and a second terminal.

The first terminal is a terminal that is installed with a shopping platform upon which a user can edit contents intended to be preset. Types of the first terminal include, but are not limited to, a personal computer, a laptop, a tablet, and a smart phone.

The second terminal is an intelligent hardware product, and the types of the intelligent hardware product include, but are not limited to, an intelligent speaker, a robot, and a smart watch, or the like. Specifically, a process for the user to preset the contents of the intelligent hardware product using the first terminal is: when browsing a detailed page of the intelligent hardware product on the shopping platform installed on the first terminal, the user edits, on the detailed page, the contents intended to be preset into the intelligent hardware product, and then sends the edited contents to the server.

The server is configured to store the contents that are edited and intended to be preset into the intelligent hardware product by the user, generate a first authentication identification according to the contents edited by the user, upon receiving an authentication request sent by the second terminal, judges whether a second authentication identification carried in the authentication request matches the first authentication identification, and if so, allow the user to access the preset contents through the intelligent hardware product.

In an embodiment, as shown in FIG. 2, the shopping platform installed on the first terminal can provide a personalized editing entry, and when purchasing the product, the user can select/enter the contents intended to be preset through the personalized editing entry. A user preference system and a user content authorization system may be set in the server, the user preference system is used to store contents edited by each user, and the user content authorization system is used for authentication and authorization of the intelligent hardware product. An authorization entry may be set in the intelligent hardware product. After receiving the intelligent hardware product, the user may send the authentication request to the server through the authorization entry.

The technical solutions of the present disclosure and how do the technical solutions of the present application solve the above technical problems will be described in detail below with specific embodiments. The following specific embodiments may be combined with each other, and the same or similar concepts or processes may not be repeated in some embodiments. Embodiments of the present disclosure will be described below with reference to the drawings.

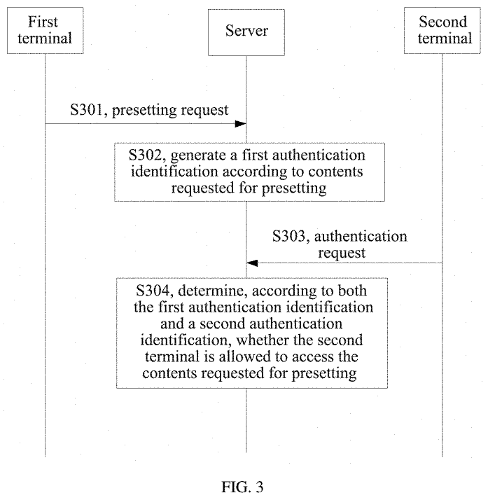

FIG. 3 is a signaling flowchart of Embodiment I of a content presetting method according to the present disclosure. As shown in FIG. 3, the content presetting method according to the present embodiment includes:

S301, a first terminal sends a presetting request to a server.

The presetting request is used to instruct to preset the contents of a second terminal, and the presetting request includes: contents requested for presetting.

Following is an example for illustrating a process of the first terminal sending the presetting request to the server:

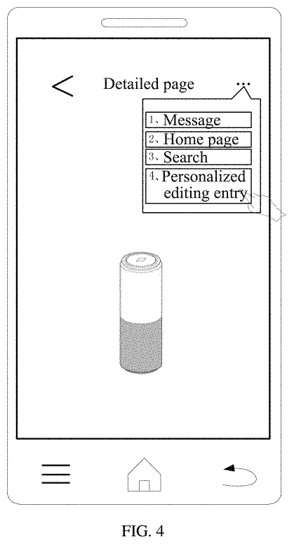

Referring to FIG. 4, when purchasing the second terminal through a shopping platform of the first terminal, the user first finds a personalized editing entry on a detailed page of the product, and edits the contents requested for presetting through the personalized editing entry. After the editing is completed, a sending instruction is triggered, and the first terminal sends a presetting request to the server according to the sending instruction.

In an embodiment, the above personalized editing entry may also be another entry for the purchase channel. For example: a popup after the user completes the purchase, or a button in a product edge of a shopping cart, or the like.

In an embodiment, the above contents requested for presetting may be a uniform resource locator URL of a song, a cross talk, or a story. The contents requested for presetting by the user are not limited in the present disclosure.

S302, the server generates a first authentication identification according to the contents requested for presetting.

The first authentication identification is in one-to-one correspondence with the contents requested for presetting, and the first authentication identification may be any one of a text identification, a two-dimensional code, or a voice password.

S303, the second terminal send s an authentication request to the server.

The authentication request includes: a second authentication identification.

S304, the server determines, according to both the first authentication identification and the second authentication identification, whether the second terminal is allowed to access the contents requested for presetting.

In an embodiment, after generating the first authentication identification, the server may return the first authentication identification to the user, after receiving the second terminal, the user may input the authentication identification (the second authentication identification) through an authorization entry on the second terminal, and sends the authentication request carrying the authentication identification to the server, so that the server determines whether the second authentication identification matches the first authentication identification, and if so, the user is allowed to access the preset contents through the second terminal.

In the content presetting method according to the present embodiment, when purchasing the intelligent hardware product, the user may send the presetting request to the server through the first terminal, and the server generates the first authentication identification according to the contents requested for presetting by the user, upon receiving the second authentication identification sent by the user through the intelligent hardware product, the server judges whether the second authentication identification matches the first authentication identification, if so, the user is allowed to access the preset contents through the intelligent hardware product, which meets personalized requirements for product contents of the user and achieves a simple process and a high user experience.

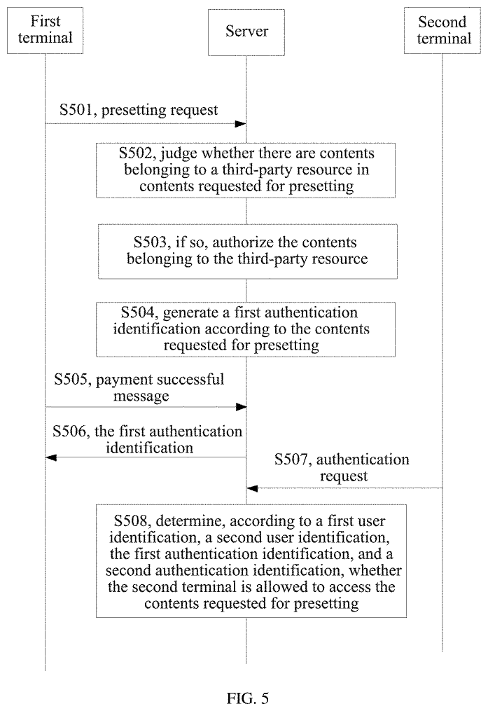

FIG. 5 is a signaling flowchart of Embodiment II of a content presetting method according to the present disclosure. As shown in FIG. 5, the content presetting method according to the present embodiment includes:

S501, a first terminal sends a presetting request to a server.

The presetting request includes: contents requested for presetting and a first user identification.

In an embodiment, the above first user identification may be an account, a nickname or an ID, or the like, registered by a user on a shopping platform. Specifically, when purchasing a second terminal through the shopping platform of the first terminal, the user first logs in to the shopping platform in an account login manner, and then finds a personalized editing entry on a detailed page of the second terminal and edits contents requested for presetting through the personalized editing entry. After the editing is completed, a sending instruction is triggered, and the first terminal sends a presetting request carrying the account and the contents requested for presetting to the server according to the sending instruction.

S502, the server judges whether there are contents belonging to a third-party resource in the contents requested for presetting.

S503, if so, authorize the contents belonging to the third-party resource.

Specifically, an interface for performing related authorization with the third-party resource may be set in the server. When the S502 judges that there are contents belonging to the third-party resource in the contents requested for presetting by the user, the authorization with the third-party resource is completed through this interface.

S504, the server generates a first authentication identification according to the contents requested for presetting.

S505, the first terminal sends a payment successful message to the server.

The payment successful message is used to indicate that a user identified by the first user identification completes a payment for the second terminal.

S506, the server returns the first authentication identification to the user identified by the first user identification according to both the payment successful message and the first user identification.

In an implementable form, the server may directly return the first authentication identification to the user identified by the first user identification through the shopping platform on the first terminal.

In another implementable form, the first user identification and other contact information of the user are bound, such as a mobile phone number. The server may determine the mobile phone number of the user according to the first user identification, and then return the first authentication identification to the user identified by the first user identification using a short message.

S507, the second terminal sends an authentication request to the server.

The authentication request includes: the second authentication identification and a second user identification;

S508, the server determines, according to the first user identification, the second user identification, the first authentication identification, and the second authentication identification, whether the second terminal is allowed to access the contents requested for presetting.

Specifically, if the first user identification matches the second user identification, and the first authentication identification matches the second authentication identification, the second terminal is allowed to access the contents requested for presetting.

The process of S501-S508 is illustratively described in the following in two cases:

in a first case, user A performs contents presetting for an intelligent speaker purchased for himself. Then, the intelligent speaker corresponds to the second terminal in the terminals of the present embodiment.

The specific process is that: the user A logs in to a shopping platform installed on a first terminal in an account login manner, an account of the user A is assumed as: AAA; then, a personalized editing entry is found on a detailed page of the intelligent speaker to be purchased, and contents intended to be preset are edited through the personalized editing entry, such as inputting an uniform resource locator URL of several songs on a certain music platform. After the editing is completed, a sending instruction is triggered, and the first terminal will send the presetting request carrying both the account AAA and the above-mentioned URL of the several songs to a server. The server judges whether there are contents belonging to a third-party resource in the above several songs, and if so, a related authorization is completed. Afterwards, the server generates a first authentication identification according to the above several songs, the first authentication identification is assumed as that: music is supreme. After the user A completes the payment for the intelligent speaker, the first terminal sends a payment successful message to the server, and the server returns the generated first authentication identification to the user A. Upon receiving the purchased intelligent speaker, the user A enters a second authentication identification through an authorization entry on the intelligent speaker, and sends an authentication request carrying the second authentication identification to the server; and the server judges whether the second authentication identification is that: music is supreme. If so, it is considered that contents of the intelligent speaker are preset, the intelligent speaker is allowed to access the preset contents, and the user A can listen to the above several songs through the intelligent speaker.

In a second case, User A performs contents presetting for an intelligent video speakers purchased for User B's child. Then, the intelligent video speaker corresponds to the second terminal in the terminals of the present embodiment.

The specific process is that: the user A logs in to a shopping platform installed on a first terminal in an account login manner, an account of the user A is assumed as: 1024; then, a personalized editing entry is found on a detailed page of the intelligent video speaker to be purchased, and contents intended to be preset are edited through the personalized editing entry, such as entering a membership number and password of “Uncle Kai telling stories”. After the editing is completed, a sending instruction is triggered, and the first terminal will send the presetting request carrying the account 1024, the membership number of the “Uncle Kai telling stories” and the password of the “Uncle Kai telling stories” to the server. The server completes the authorization with a third party according to the membership number of the “Uncle Kai telling stories” and the password of the “Uncle Kai telling stories”. Then, the server generates a first authentication identification according to the “Uncle Kai telling stories”; and the first authentication identification is assumed as: 6666. After the user A completes the payment for the intelligent video speaker, the first terminal sends a payment successful message to the server, and the server returns the generated first authentication identification to the user A. The user A informs the user B of account 1024 and first authentication identification 6666. When receiving the intelligent video speaker purchased by the user A, the user B enters a second authentication identification and a second user identification through an authorization entry on the intelligent video speaker, and sends an authentication request carrying the second authentication identification and the second user identification to the server; the server judges whether the second authentication identification is: 6666, and judges at the same time whether the second user identification is: 1024. If so, it is considered that contents of the intelligent video speaker are preset, the intelligent video speaker is allowed to access the preset contents, and the child of the User B can listen to the “Uncle Kai telling stories” through the intelligent video speaker.

The content presetting method according to the present embodiment, when generating the first authentication identification, the server returns the first authentication identification to the user, so that after receiving the purchased product, the user may complete the related authorization using the first authentication identification, so as to enable the access to the preset contents.

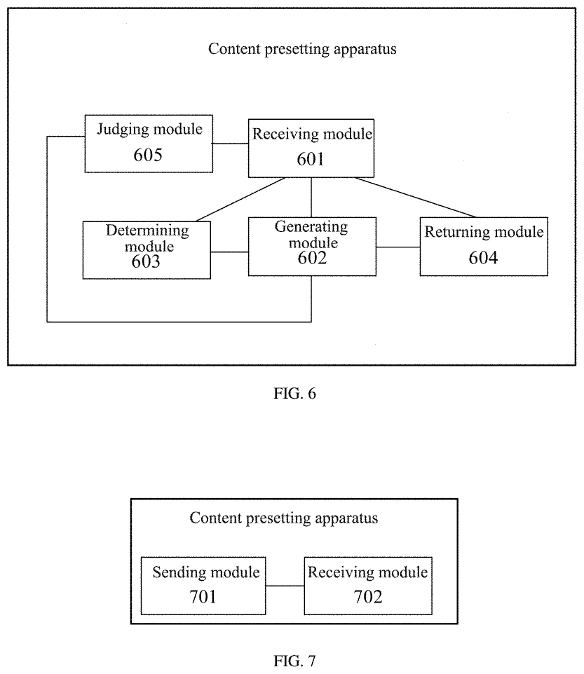

FIG. 6 is a schematic structural diagram of Embodiment I of a content presetting apparatus according to the present disclosure. As shown in FIG. 6, the content presetting apparatus according to the present embodiment includes:

a receiving module 601, configured to receive a presetting request sent by a first terminal, where the presetting request is used to instruct to preset contents of a second terminal, and the presetting request includes: contents requested for presetting;

a generating module 602, configured to generate a first authentication identification according to the contents requested for presetting;

the receiving module 601 is further configured to receive an authentication request sent by the second terminal, where the authentication request includes: a second authentication identification; and

a determining module 603, configured to determine, according to both the first authentication identification and the second authentication identification, whether the second terminal is allowed to access the contents requested for presetting.

In an embodiment, the presetting request includes: the contents requested for presetting and a first user identification; the apparatus according to the present embodiment further includes: a returning module 604;

the receiving module 601 is further configured to receive a payment successful message sent by the first terminal, where the payment successful message is used to indicate that a user identified by the first user identification completes a payment for the second terminal; and

the returning module 604 is configured to return the first authentication identification to the user identified by the first user identification according to both the payment successful message and the first user identification.

In an embodiment, the authentication request includes: the second authentication identification and a second user identification, and the determining module 603 is configured to determine, according to the first user identification, the second user identification, the first authentication identification, and the second authentication identification, whether the second terminal is allowed to access the contents requested for presetting.

In an embodiment, the determining module 603 is specifically configured to: allow the second terminal to access the contents requested for presetting if the first user identification matches the second user identification, and the first authentication identification matches the second authentication identification.

In an embodiment, the apparatus according to the present embodiment further includes:

a judging module 605, configured to judge whether there are contents belonging to a third-party resource in the contents requested for presetting; and

if so, authorizing the contents belonging to the third-party resource.

In an embodiment, the first authentication identification includes: a text identification, a two-dimensional code, or a voice password.

The content presetting apparatus according to the present embodiment may be used to perform the steps performed on the server side in any one of the preceding method embodiments. The specific implementation principle may refer to the preceding embodiments, which will not be repeated in the present embodiment.

FIG. 7 is a schematic structural diagram of Embodiment II of a content presetting apparatus according to the present disclosure. As shown in FIG. 7, the content presetting apparatus according to the present embodiment includes:

a sending module 701, configured to send a presetting request to a server, where the presetting request is used to instruct to preset contents of a second terminal, and the presetting request includes: contents requested for presetting and a first user identification, so as to enable the server to generate a first authentication identification according to the contents requested for presetting;

the sending module 701 is further configured to send a payment successful message to the server, where the payment successful message is used to indicate that a user identified by the first user identification completes a payment for the second terminal; and

a receiving module 702, configured to receive the first authentication identification sent by the server.

The content presetting apparatus according to the present embodiment may be used to perform the steps performed on the first terminal side in any one of the preceding method embodiments. The specific implementation principle may refer to the preceding embodiments, which will not be repeated in the present embodiment.

FIG. 8 is a schematic structural diagram of hardware of a server according to the present disclosure. As shown in FIG. 8, the server in the present embodiment may include:

a memory 801, configured to store program instructions.

a processor 802, configured to implement steps performed on the server side in any one of the preceding method embodiments when the program instructions are executed. The specific implementation principle may refer to the preceding embodiments, which will not be repeated in the present embodiment.

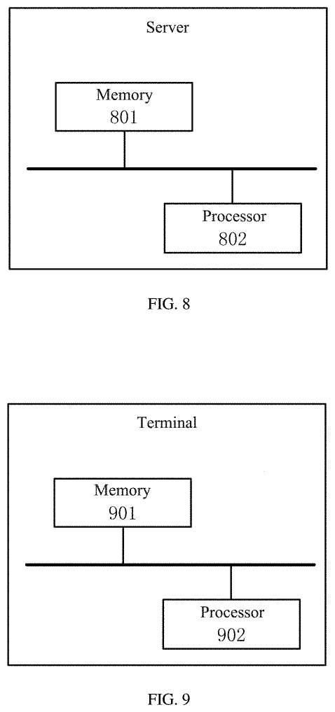

FIG. 9 is a schematic structural diagram of hardware of a terminal according to the present disclosure. As shown in FIG. 9, the terminal in the present embodiment may include:

a memory 901, configured to store program instructions.

a processor 902, configured to implement steps performed on the first terminal side in any one of the preceding method embodiments when the program instructions are executed. The specific implementation principle may refer to the preceding embodiments, which will not be repeated in the present embodiment.

The present disclosure provides a computer readable storage medium with a computer program stored thereon, where the computer program, when executed by the processor, implements steps performed on the server side in any one of the preceding method embodiments.

The present disclosure provides a computer readable storage medium with a computer program stored thereon, where the computer program, when executed by the processor, implements steps performed on the first terminal side in any one of the preceding method embodiments.

The present disclosure also provides a program product, the program product includes a computer program stored in a readable storage medium, at least one processor may read the computer program from the readable storage medium, and the at least one processor executes the computer program so as to cause the server to perform the steps performed on the server side in any one of the preceding method embodiments.

The present disclosure also provides a program product, the program product includes a computer program stored in a readable storage medium, at least one processor may read the computer program from the readable storage medium, and the at least one processor executes the computer program so as to cause the server to perform the steps performed on the first terminal side in any one of the preceding method embodiments

In the several embodiments according to the present disclosure, it should be understood that the disclosed apparatus and method may be implemented in other manners. For example, the apparatus embodiments described above are merely illustrative. For example, the division of the unit is only a logical function division, and there may be another division manner in actual implementation; for example, multiple units or components may be combined or may be integrated into another system, or some features can be ignored or not be executed. In addition, the mutual coupling or direct coupling or communication connection shown or discussed may be an indirect coupling or communication connection through some interfaces, apparatuses or units, and may be in an electrical form, mechanical form or in other forms.

The unit described as a separate component may or may not be physically separated, and the component displayed as a unit may or may not be a physical unit, that is, may be located in one place, or may be distributed to multiple network units. Some or all the units may be selected as required, to achieve the purpose of the solution of the embodiment.

In addition, each functional unit in each embodiment of the present disclosure may be integrated into one processing unit, or each unit may exist physically separately, or two or more units may be integrated into one unit. The above integrated unit can be implemented in the form of hardware or in the form of hardware plus software functional units.

The integrated unit described above implemented in the form of a software functional unit can be stored in a computer readable storage medium. The above software functional unit is stored in a storage medium and includes instructions for causing a computer device (may be a personal computer, a server, or a network device, etc.) or a processor to perform part of the steps of the methods according to the various embodiments of the present disclosure. The above storage medium includes media that store program codes such as a U disk, a mobile hard disk, a read-only memory (ROM), a random access memory (RAM), a magnetic disk, or an optical disk.

It should be understood that the processor may be a Central Processing Unit (CPU), or may be other general processors, a Digital Signal Processor (DSP), an Application Specific Integrated Circuit (ASIC), etc. The general processor may be a microprocessor, or the processor may be any conventional processor or the like. Steps of the method disclosed with reference to the present application may be directly implemented by a hardware processor, or may be performed by a combination of hardware and software modules in the processor.

Finally, it should be noted that the above embodiments are merely illustrative of the technical solutions of the present disclosure, and are not to be taken in a limiting sense; although the present disclosure has been described in detail with reference to the above embodiments, those skilled in the art will understand that they may still modify the technical solutions described in the above embodiments, or equivalently substitute some or all of the technical features; and the modifications or substitutions do not deviate the nature of the corresponding technical solutions from the scope of the technical solutions of the embodiments of the present disclosure.

What is claimed is:

1. A content presetting method, comprising:
receiving, by a server, a presetting request sent by a first terminal, wherein the presetting request is used to instruct to preset contents of a second terminal, and the presetting request comprises: contents requested for presetting;
generating, by the server, a first authentication identification according to the contents requested for presetting;
receiving, by the server, an authentication request sent by the second terminal, wherein the authentication request comprises: a second authentication identification; and
determining, by the server, according to both the first authentication identification and the second authentication identification, whether the second terminal is allowed to access the contents requested for presetting.

2. The method of claim 1, wherein the presetting request comprises: the contents requested for presetting and a first user identification;
before the receiving, by the server, an authentication request sent by the second terminal, the method further comprises:
receiving, by the server, a payment successful message sent by the first terminal, wherein the payment successful message is used to indicate that a user identified by the first user identification completes a payment for the second terminal.

3. The method of claim 2, wherein after the receiving, by the server, a payment successful message sent by the first terminal, the method further comprises:
returning, by the server, the first authentication identification to the user identified by the first user identification according to both the payment successful message and the first user identification.

4. The method of claim 3, wherein the authentication request comprises: the second authentication identification and a second user identification;
the determining, by the server, according to both the first authentication identification and the second authentication identification, whether the second terminal is allowed to access the contents requested for presetting, comprises:
determining, by the server, according to the first user identification, the second user identification, the first authentication identification, and the second authentication identification, whether the second terminal is allowed to access the contents requested for presetting.

5. The method of claim 4, wherein the determining, by the server, according to the first user identification, the second user identification, the first authentication identification, and the second authentication identification, whether the second terminal is allowed to access the contents requested for presetting, comprises:
allowing the second terminal to access the contents requested for presetting if the first user identification matches the second user identification, and the first authentication identification matches the second authentication identification.

6. The method of claim 5, wherein before the generating, by the server, a first authentication identification according to the contents requested for presetting, the method further comprises:
judging, by the server, whether there are contents belonging to a third-party resource in the contents requested for presetting; and
if so, authorizing the contents belonging to the third-party resource.

7. The method of claim 6, wherein an interface for performing the authorization with the third-party resource is set in the server.

8. The method of claim 5, wherein the first authentication identification comprises: a text identification, a two-dimensional code, or a voice password.

9. The method of claim 3, wherein the returning, by the server, the first authentication identification to the user identified by the first user identification according to both the payment successful message and the first user identification comprises:
directly returning, by the server, the first authentication identification to the user identified by the first user identification through a shopping platform on the first terminal according to both the payment successful message and the first user identification.

10. A content presetting apparatus, comprising:
a transceiver, a memory, a processor, and a computer program stored on the memory and operable on the processor,
wherein the processor, when running the computer program, is configured to:
control the transceiver to receive a presetting request sent by a first terminal, wherein the presetting request is used to instruct to preset contents of a second terminal, and the presetting request comprises: contents requested for presetting;
generate a first authentication identification according to the contents requested for presetting;
control the transceiver to receive an authentication request sent by the second terminal, wherein the authentication request comprises: a second authentication identification; and
determine, according to both the first authentication identification and the second authentication identification, whether the second terminal is allowed to access the contents requested for presetting.

11. The content presetting apparatus of claim 10, wherein the presetting request comprises: the contents requested for presetting and a first user identification,
the processor is further configured to control the transceiver to receive a payment successful message sent by the first terminal, wherein the payment successful message is used to indicate that a user identified by the first user identification completes a payment for the second terminal.

12. The content presetting apparatus of claim 11, wherein the processor is further configured to return the first authentication identification to the user identified by the first user identification according to both the payment successful message and the first user identification.

13. The content presetting apparatus of claim 12, wherein the authentication request comprises: the second authentication identification and a second user identification; and the processor is further configured to determine according to the first user identification, the second user identification, the first authentication identification, and the second authentication identification, whether the second terminal is allowed to access the contents requested for presetting.

14. The content presetting apparatus of claim 13, wherein the processor is further configured to allow the second terminal to access the contents requested for presetting if the first user identification matches the second user identification, and the first authentication identification matches the second authentication identification.

15. The content presetting apparatus of claim 14, wherein the processor is further configured to judge whether there are contents belonging to a third-party resource in the contents requested for presetting; and
if so, authorize the contents belonging to the third-party resource.

16. The content presetting apparatus of claim 14, the first authentication identification comprises: a text identification, a two-dimensional code, or a voice password.

17. The content presetting apparatus of claim 12, wherein the processor is further configured to directly return the first authentication identification to the user identified by the first user identification through a shopping platform on the first terminal according to both the payment successful message and the first user identification.

18. A content presetting apparatus, comprising:
a transceiver, a memory, a processor, and a computer program stored on the memory and operable on the processor,
wherein the processor, when running the computer program, is configured to:
control the transceiver to send a presetting request to a server, wherein the presetting request is used to instruct to preset contents of a second terminal, and the presetting request comprises: contents requested for presetting and a first user identification, so as to enable the server to generate a first authentication identification according to the contents requested for presetting;
control the transceiver to send a payment successful message to the server, wherein the payment successful message is used to indicate that a user identified by the first user identification completes a payment for the second terminal; and
control the transceiver to receive the first authentication identification sent by the server.

19. The content presetting apparatus of claim 18, wherein the first authentication identification comprises: a text identification, a two-dimensional code, or a voice password.

20. The content presetting apparatus of claim 18, wherein the processor is further configured to control the transceiver to receive the first authentication identification sent by the server through a shopping platform on the content presetting apparatus.
